(19) United States
(12) Patent Application Publication
(10) Pub. No.: US 2006/0110030 A1
(43) Pub. Date: May 25, 2006

(54) Method, medium, and apparatus for eye detection

(75) Inventor: Young-hun Sung, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/284,108

(22) Filed: Nov. 22, 2005

(30) Foreign Application Priority Data
Nov. 24, 2004 (KR) 10-2004-0096931

(51) Int. Cl. G06K 9/62; G06K 9/46

(52) U.S. Cl. 382/159; 382/190

(57) ABSTRACT

A method, medium, and apparatus for eye detection. The apparatus for eye detection may include an image pre-processing unit pre-processing an input face image to divide it into a left image and a right image, an eye candidate extraction unit applying a morphology operator to each of the left and right images and extracting data on first eye candidates for a left eye and data on first eye candidates for a right eye, an eye candidate verification unit verifying the data on the first eye candidates using a binary classifier and extracting data on second eye candidates for each of the left and right eyes, and a final verification unit verifying data on pairs of left and right eyes, which is generated from the data on the second eye candidates for the left and right eyes, using a binary classifier and extracting final eye data.

### CROSS-REFERENCE TO RELATED APPLICATIONS

This application claims priority from Korean Patent Application No. 10-2004-0096931 filed on Nov. 24, 2004 in the Korean Intellectual Property Office, the disclosure of which is incorporated herein by reference in its entirety.

### BACKGROUND OF THE INVENTION

1. Field of the Invention

Embodiments of the present invention relate to a method, medium, and apparatus for eye detection, and more particularly, to a method, medium, and apparatus in which an input face image is divided into left and right images, a morphology operator is applied to each image to extract data on a first eye candidate for each of left and right eyes, the data on the first eye candidate is verified using a binary classifier to extract data on a second eye candidate for each of the left ad right eyes, two eyes are constructed with the data on the second eye candidates, and a pair of the two eyes are verified using the binary classifier to extract positions of final eyes, thereby detecting eyes accurately and quickly.

2. Description of the Related Art

With the advancement of information throughout society, identification technology for distinguishing between people is becoming increasingly important. A biometric, for example, is a measurement of any physical characteristic or personal trait of an individual that can be used to protect personal information or authenticate the identity of that individual using computer technology. Different forms of biometrics are well known and face recognition particularly provides several advantages, including permitting the collection of identification in a non-contact manner, making it convenient and competitive, compared to other forms of biometrics such as fingerprints or iris scans, which require an individual's specific action or behavior. Facial recognition technology, which is an important component of multimedia database retrieval systems, is becoming more important as a variety of applications are becoming more desirable, including face-based motion video extraction, identification, Human Computer Interface (HCI) image retrieval, security, and monitoring systems.

For accurate face recognition, face localization must be accomplished accurately. For the accurate face localization, eye positions must be detected accurately. Apparatuses and methods for detecting the positions of eyes from a face image have been discussed in many patent documents. For example, a system for detecting a face and eye positions using a T-shape search area was discussed in Korean Patent No. 10-0292,380. Here, the system extracts edge information from an input image and matches the edge information with a T-shape template, thereby extracting a face and an eye region. In addition, an apparatus and method for detecting eye positions was further discussed in Korean Patent Publication No. 1999-028570. In the apparatus and method, eye positions in a face image are detected using a histogram.

FIG. 1 is a schematic block diagram of a conventional eye position detecting system 100 set forth in U.S. Pat. No. 5,293,427, entitled “Eye Position Detecting System and Method therefor”.

Here, the eye position detecting system 100 includes an infrared strobe 20, a TV camera 30, an analog-to-digital (A/D) converter 40, an image memory 50, an eye window detector 60, an iris detector 70, an inattentive driver discriminator 80, and a timing circuit 10. The infrared strobe 20 emits infrared rays upon a driver's face. The TV camera 30 takes images of the driver's face irradiated with the infrared rays. The timing circuit 10 matches the timing at which the infrared rays are emitted from the infrared strobe 20 with that at which the driver's face image is taken by the TV camera 30. The A/D converter 40 converts analog image signals obtained by the TV camera 30 into digital image signals, and the image memory 50 stores these digital image signals. The eye window detector 60 detects an area or areas within which two eyes exist on the basis of the image signals stored in the image memory 50. The iris detector 70 detects an iris position within the area detected by the eye window detector 60. The inattentive driver discriminator 80 then discriminates between an inattentive driver who is dozing or is looking aside based on the result of the detection by the iris detector 70.

However, since conventional eye position detecting methods and apparatuses use a morphology operator or histogram analysis with respect to an entire face image, they are also very sensitive to any change in illumination and both eyes may not be detected accurately and simultaneously. In addition, an additional device such as an infrared strobe is required.

### SUMMARY OF THE INVENTION

Embodiments of the present invention provide a method, medium, and apparatus for eye detection that are robust to illumination.

Embodiments of the present invention also provide a method, medium, and apparatus for eye detection, by which both of two eyes are accurately detected.

Embodiments of the present invention also provide a method, medium, and apparatus for eye detection, by which an eye position is detected quickly and accurately.

To achieve the above and/or other aspects and advantages, embodiments of the present invention include an apparatus for eye detection, including an image pre-processing unit to pre-process an input face image to divide the input face image into a left image and a right image, an eye candidate extraction unit to apply a morphology operator to each of the left and right images and to extract data on first eye candidates for a left eye and data on first eye candidates for a right eye, an eye candidate verification unit to verify the data on the first eye candidates of the left eye and the data on the first eye candidates of the right eye using an eye candidate verification unit binary classifier and extracting respective data on second eye candidates for each of the left and right eyes, and a final verification unit to verify data on pairs of left and right eyes, generated from the respective data on the second eye candidates for the left and right eyes, using a final verification unit binary classifier and extracting final eye data.

The apparatus may further include a training data storage unit to store training data to train the eye candidate verification unit binary classifier and the final verification unit binary classifier for a discrimination reference.

The image pre-processing unit may perform histogram normalization on the face image and divide the normalized face image into the left image and the right image.

The eye candidate extraction unit may include a morphology operation section to apply the morphology operator to each of the left and right images, and a contour extractor to extract respective contours from each of the left and right images that have been subjected to the application of the morphology operator and to obtain central coordinate values of the respective contours. The apparatus may further include a binarizer to separately binarize the left image and the right image. In addition, the respective contours may satisfy a predetermined condition.

The eye candidate verification unit may include the eye candidate verification unit binary classifier to verify a predetermined region according to each first eye candidate, and a sorter to sort the first eye candidates according to a verification result and selecting at least some of the first eye candidates based on highest levels from sorted verification results as the second eye candidates.

The eye candidate verification unit binary classifier may include a learning section learning a discrimination reference, and a discrimination section verifying input data based on the discrimination reference. The eye candidate verification unit binary classifier may be an AdaBoost classifier.

The final verification unit may include a normalizer to normalize data on pairs of left and right eyes, and the final verification unit binary classifier verifying the normalized data on the pairs of the left and right eyes. The final verification unit binary classifier may include a learning section learning a discrimination reference, and a discrimination section verifying input data based on the discrimination reference. The final verification unit binary classifier may be a support vector machine (SVM) classifier. In addition, the final verification unit binary classifier may include at least two different facial characteristic binary classifiers.

To achieve the above and/or other aspects and advantages, embodiments of the present invention include an method for eye detection, including pre-processing an input face image to divide the face image into a left image and a right image, applying a morphology operator to each of the left and right images and extracting data on first eye candidates for a left eye and data on first eye candidates for a right eye, verifying the data on the first eye candidates for the left eye and the data on the first eye candidates for the right eye using a first eye candidate binary classifier and extracting respective data on second eye candidates for each of the left and right eyes, and verifying data on pairs of left and right eyes, generated from the data on the respective second eye candidates for the left and right eyes, using a second eye candidate binary classifier and extracting final eye data.

The pre-processing of the input face image may include performing histogram normalization on the face image, and dividing the normalized face image into the left image and the right image.

The applying of the morphology operator may include applying the morphology operator to each of the left and right images, and extracting respective contours from each of the left and right images that have been subjected to the application of the morphology operator and obtaining central coordinate values of the respective contours. The method may further include separately binarizing the left image and the right image before applying the morphology operator. In addition, the contours may satisfy a predetermined condition.

The applying of the morphology operator and the extracting of the contours may be repeatedly performed until contours satisfying the predetermined condition are extracted.

The verifying of the data on the first eye candidates may include verifying a predetermined region based on each first eye candidate using the first eye candidate binary classifier, and sorting the first eye candidates according to a verification result and selecting at least some of the first eye candidates based on highest levels from sorted verification results as the second eye candidates.

The method may further include learning a discrimination reference using the first eye candidate binary classifier, wherein the verifying of the predetermined region further includes verifying the predetermined region according to the discrimination reference.

The first eye candidate binary classifier may be an AdaBoost classifier.

In addition, the verifying of data on pairs of left and right eyes, includes normalizing the data on pairs of left and right eyes, and verifying the normalized data on pairs of the left and right eyes. The method may include learning a discrimination reference using the second eye candidate binary classifier, wherein the verifying of the predetermined region further includes verifying the predetermined region according to the discrimination reference.

The second eye candidate binary classifier may be a support vector machine (SVM) classifier. In addition, the second eye candidate binary classifier may include at least two different facial characteristic binary classifiers.

To achieve the above and/or other aspects and advantages, embodiments of the present invention include at least one medium including computer readable code to implement an embodiment of the present invention.

To achieve the above and/or other aspects and advantages, embodiments of the present invention include an apparatus for eye detection, including a means for pre-processing an input face image to divide the face image into a left image and a right image, a means for applying a morphology operator to each of the left and right images and extracting data on first eye candidates for a left eye and data on first eye candidates for a right eye, a means for verifying the data on the first eye candidates for the left eye and the data on the first eye candidates for the right eye and extracting respective data on second eye candidates for each of the left and right eyes, and a means for verifying data on pairs of left and right eyes and extracting final eye data.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a conventional eye position detecting apparatus;

FIG. 2 illustrates an eye detecting apparatus, according to an embodiment of the present invention;

FIG. 3 illustrates an eye candidate extraction unit included in an eye detecting apparatus, such as that shown in FIG. 2, according to an embodiment of the present invention;

FIG. 4 illustrates an eye candidate verification unit included in an eye detecting apparatus, such as that shown in FIG. 2, according to an embodiment of the present invention;

FIG. 5 illustrates a final verification unit included in an eye detecting apparatus, such as that shown in FIG. 2, according to an embodiment of the present invention;

FIG. 6 illustrates a final verification unit, according to another embodiment of the present invention;

FIG. 7 is a flowchart illustrating an eye detecting method, according to an embodiment of the present invention;

FIG. 8 is a flowchart illustrating a procedure for first eye candidate extraction, such as that shown in FIG. 7, according to an embodiment of the present invention; and

FIG. 9 is a flowchart illustrating a procedure for second eye candidate extraction, such as that shown in FIG. 7, according to an embodiment of the present invention.

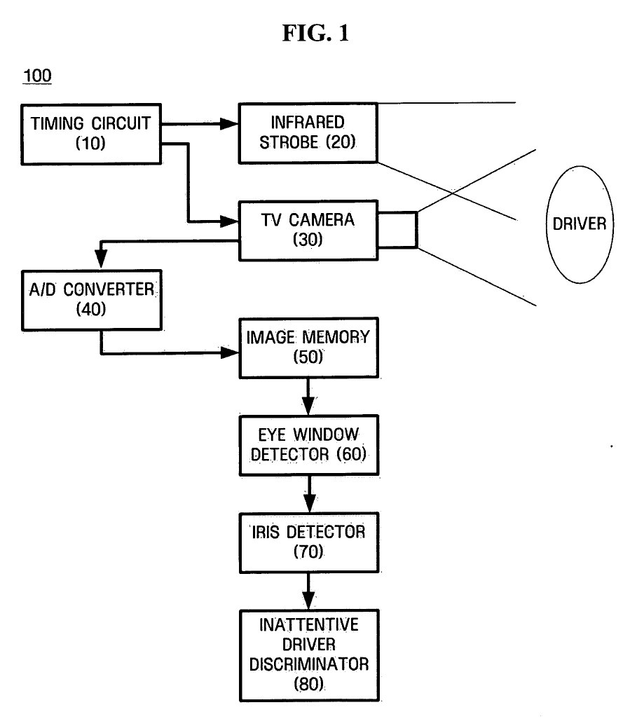

### DETAILED DESCRIPTION OF THE PREFERRED EMBODIMENTS

Advantages and features of the present invention may be understood more readily by reference to the following detailed description of embodiments of the present invention and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art. Like reference numerals refer to like elements throughout the specification.

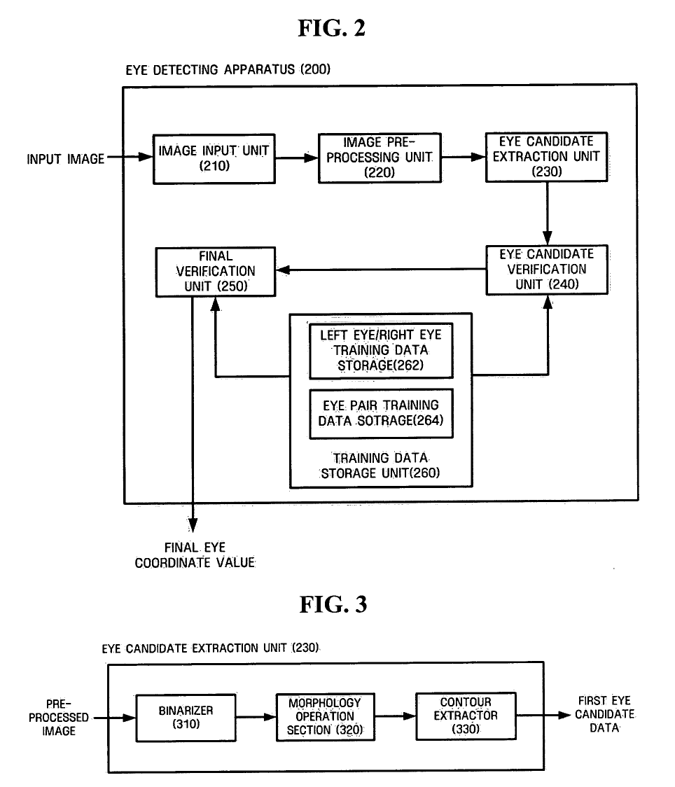

Referring to FIG. 2, an eye detecting apparatus 200, according to an embodiment of the present invention, may include an image input unit 210, an image pre-processing unit 220, an eye candidate extraction unit 230, an eye candidate verification unit 240, a final verification unit 250, and a training data storage unit 260, for example. The training data storage unit 260 may be divided into a left eye/right eye training data storage 262 storing training data for individual left and right eyes and an eye pair training data storage 264 storing training data for the final verification unit 250. The left eye/right eye training data storage 262 and the eye pair training data storage 264 may be implemented in a single unit as shown in FIG. 2 or may be implemented in independent units, respectively.

The image input unit 210 may receive an input image including a face image and may convert the input image to pixel values. The image pre-processing unit 220 may convert the face image received from the image input unit 210 to an appropriate size and perform a process such as histogram normalization to reduce the influence of illumination. Due to the influence of illumination, input images may have relatively high or low brightness. Even in a single input image, brightness may be higher or lower in one portion than in another portion. To reduce the influence of illumination, the image pre-processing unit 220 analyzes brightness distribution of individual pixels in the face image to obtain a histogram and normalizes the distribution of pixel values in the face image. With such operations, a binarization reference value can be selected. When the pixel values forms normal distribution, an image generally looks natural. In an embodiment of the present invention, the histogram normalized image may be divided into a left image including a left side of the face and a right image including a right side of the face and output as left and right images to the eye candidate extraction unit 230.

Referring to FIG. 3, the eye candidate extraction unit 230 may include a binarizer 310, a morphology operation section 320, and a contour extractor 330, for example. The eye candidate extraction unit 230 may binarize the left and right images received from the image pre-processing unit 220 and apply a morphology operator to the left and right images, respectively, thereby extracting contours that may be eye candidates.

The binarizer 310 may perform binarization by allocating a value of 0 when a pixel value is at least a predetermined threshold value and allocating a value of 255 when a pixel value is greater than the predetermined threshold value with respect to each of the left and right images. The threshold value for the binarization may be obtained during the histogram normalization by the image pre-processing unit 220 or may be adaptively determined by performing binarization with a small value while increasing the value until a satisfactory contour is extracted, for example. The binarization may not be essential to implementing embodiments of the present invention. For example, without the binarization, a morphology operator may be applied to a grayscale image.

The morphology operation section 320 may apply a morphology operator to each of the left and right images of the input image to remove noise from each image and extract simplified feature points therefrom, and to extract a contour of the feature points. Mathematical morphology is designed to analyze a geometric structure in an image. An erosion operator and a dilation operator are basic morphology operators. The erosion operator and the dilation operator need two sets as an input: an image to be analyzed and a structuring element corresponding to a filter converting the image.

Erosion clips detailed texture of an image by removing isolated points, small particles, and peaks on the boundary of a feature point, thereby generating a plain and smooth image. In an erosion algorithm, a value of every binary pixel that is n-connected to a background pixel having a value of 0, and has a value of 1, is set to 0.

Dilation expands a boundary or an area of foreground pixels having the value of 1 so that a foreground pixel area increases and a hole within the foreground pixel area decreases. In a dilation algorithm, a value of every background pixel n-connected to a binary pixel having the value of 1 is set to 1.

In an embodiment of the present invention, an opening operation, where the dilation operator is applied after the erosion operator is applied, may be performed on each of the binarized left and right images. The opening operation may remove detailed parts of an image that are smaller than the structuring element, find an object having a desired shape, smooth the boundary of the object, and remove noise.

The contour extractor 330 may extract contours of the feature points corresponding to eyes found by the morphology operation section 320, extract central coordinate values of the respective contours, and set the central coordinate values as first eye candidates.

In an embodiment of the present invention, both of binarization and morphology operation are performed separately in each of the left and right images in the face image, and therefore, satisfactory candidates for each of the left and right eye can be extracted even when the brightness of the left image is different from that of the right image. As a result, eye detection robust to illumination becomes possible.

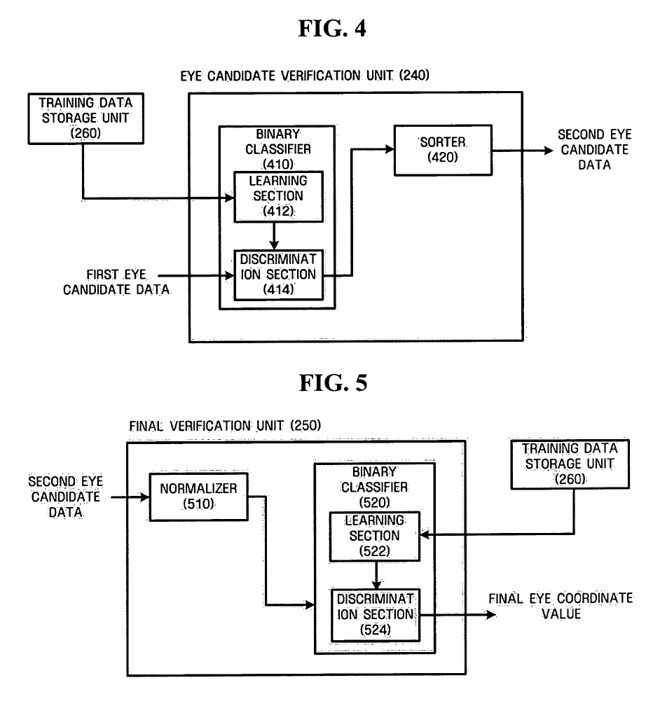

The eye candidate verification unit 240 may verify a search region having a predetermined size based on each central coordinate value, extracted as the first eye candidate by the eye candidate extraction unit 230, and may extract second eye candidates for each of the left and right eyes. Referring to FIG. 4, the eye candidate verification unit 240 may include a binary classifier 410 and a sorter 420, for example. A predetermined region may be defined in an image based each central coordinate value set as the first eye candidate and input to the binary classifier 410 that has already been trained. Then, the binary classifier 410 can verify whether an image portion, corresponding to each first eye candidate, includes an eye based on a verification reference generated through training. The sorter 420 then may sort the first eye candidates according to the verification result of the binary classifier 410 and extract second eye candidates for each of the left and right eyes by selecting, for example, three or four first eye candidates on the highest levels from the result of the sorting.

The binary classifier 410 may use an AdaBoost method, a support vector machine (SVM) method, or a neural network (NN) method, for example, for binary classification. In the binary classification, a training set, including data included in a target group and data not included in the target group, may be used to determine whether input data is included in the target group. Although all of an AdaBoost, an SVM, and an NN may be used for the binary classifier 410, a verification method using the AdaBoost will be described in greater detail below in an embodiment of the present invention.

In the AdaBoost method, a weak learner may be executed a plurality of times with respect to the training set changing a little and hypotheses resulting from the plurality of executions may be combined to make a single final hypothesis. As a result, a hypothesis having higher accuracy than a hypothesis of the weak learner may be obtained.

A main idea of the AdaBoost method is the allocating of a weight to an example of a given training set. Initially, all weights are the same, but whenever a weak learner returns a hypothesis, weights for all examples that are wrongly classified by the hypothesis are increased. In this way, the weak learner concentrates on difficult examples of the training set. A final hypothesis corresponds to a combination of hypotheses generated in previous executions. In other words, a hypothesis having a lower classification error has a higher weight.

Hereinafter, the AdaBoost method used in an embodiment of the present invention will be described in greater detail.

A set E={(x1, y1), . . . , (xn, yn)} can be defined as a set of classified examples, where i=1, . . . , n, xᵢεX, and yᵢεY. In addition, it will be assumed herein that Y={−1,+1}, that is, an example has a value of −1 when the example is not included in the conception to be learned and has a value of +1 when the example is included in the conception to be learned. A weak learning algorithm reads the example set E and weights D. Thus, an AdaBoost algorithm is as follows:

When Dₜ(i) is a weight for an example “i” at a t-th round,

1. Initialization: a weight D₁(i):=1/n is allocated to each example (xᵢ, yᵢ)εE,

2. For t=1 to T:

(1) Call the weak learning algorithm using the example set E and the weight Dₜ;

(2) Obtain a weak hypothesis hₜ: X→R; and

(3) Change weights for all examples, and

3. A procedure of changing a weight at the t-th round for outputting a final hypothesis generated from first through T-th round hypotheses can be defined by the below Equation (1).
Dₜ₊₁(i):=Dₜ(i)*exp(αₜyᵢhₜ(xᵢ))/Zₜ (1)

Here, Zₜ may be chosen so that Dₜ₊₁ will be a distribution and at may be chosen according to the importance of the hypothesis hₜ. With respect to a hypothesis hₜ: X→{−1, 1}, αₜ may be chosen according to the below Equation (2).
αₜ:=½*ln((1−ε₁)/εₜ) (2)

Here, εₜ may be a classification error of the hypothesis hₜ. A final hypothesis H: X→{−1, 1} may be chosen according to the below Equation (3).

$$H ( X ) = sign ( {\sum }_{t = 1}^{T} {α}_{t} {h}_{t} ( x ) ) \qquad ( 3 )$$

According to the above-described mechanism, a learning section 412, included in the binary classifier 410, may learn a reference for discriminating an image including an eye using training data including a plurality of images including an eye and a plurality of images not including an eye, which can be stored in the left eye/right eye training data storage 262 with respect to each of the left and right eyes. A discrimination section 414, included in the binary classifier 410, using the AdaBoost method, may receive an image vector of each first eye candidate, i.e., a vector indicating an image of the search region set based on the central coordinate value of each contour extracted as a first eye candidate, and may generate verification values of the respective first eye candidates for the left eye and verification values of the respective first eye candidates for the right eye.

The sorter 420 may sort the verification values, select as second eye candidates three or four first eye candidates based on their highest levels with respect to each of the left and right eyes, and transmit the second eye candidates for the left eye and the second eye candidates for the right eye to the final verification unit 250.

Referring to FIG. 5, the final verification unit 250 may include a normalizer 510 and a binary classifier 520. The normalizer 510 adjusts the height and the size of left and right eyes for balance with respect to all pairs of left and right eyes, which can be generated by combination of the second eye candidates for the left eye and the second eye candidates for the right eye, and adjusts the position of a feature point corresponding to an eye in an image of each pair of left and right eyes so that the image of each pair can be compared with the training data.

The binary classifier 520 may verify the image of each pair of normalized left and right eyes and finally detect the respective eyes. The final verification unit 250 may use the AdaBoost method, the SVM method, the NN method, etc., for binary classification. In an embodiment of the present invention, verification using the SVM method can be implemented, as will now be described in greater detail below.

The binary classifier 520 may be included in the final verification unit 250 and may include a learning section 522 and a discrimination section 524. The learning section 522 may generate a binary discrimination reference using a plurality of training image vectors stored in the eye pair training data storage 264. The discrimination section 524 may receive a vector of the image of each of the pairs of left and right eyes, which can be generated from the second eye candidates for the left eye and the second eye candidates for the right eye, and discriminates whether the image of each pair includes eyes based on the binary discrimination reference.

When the binary classifier 520 uses the SVM method, the generation of the binary discrimination reference in the learning section 522 will correspond to a procedure of obtaining an optimal hyperplane. In addition, the discrimination performed by the discrimination section 524 will correspond to a procedure of applying the image of each pair of left and right eyes to a discriminant of the optimal hyperplane and determining whether a resultant value exceeds a predetermined threshold value. In the SVM method, two regions defined by a single optimal hyperplane may be referred to as classes. In an embodiment of the present invention, images formed using the second eye candidates may be divided into a class including eyes and a class not including eyes.

A procedure for obtaining the optimal hyperplane in the SVM method, according to an embodiment of the present invention, will be described with reference to Equations (4) through (12). In an embodiment of the present invention, training data input to an SVM may include a plurality of images including eyes and a plurality of images not including eyes. The training data may be expressed by the below Equation (4):
(y₁,x₁), . . . ,(y₁,x₁),xεRⁿ,yε{−1,+1} (4)

Here, xₗ may be a vector of “l” training images and yₗ may be a target output.

When two classes can be obtained using linear division, they can be defined by a hyperplane expressed by the below Equation (5):
(w·x)−b=0 (5)

Here, “w” may be a normal vector with respect to the hyperplane and “b” may be a constant.

Among hyperplanes defined by Equation (5), a hyperplane having a maximum distance to the nearest data point may be referred to as an optimal hyperplane and data nearest to the optimal hyperplane may be referred to as a support vector.

To determine “w” and “b” with respect to the optimal hyperplane in Equation (5), the below Equation (6) may be solved.

$${min}_{w , b} \frac{1}{2} {‖ w ‖}^{2} , subject to {y}_{i} ( w \cdot {x}_{i} - b ) \geq 1 , \qquad ( 6 )$$

Here, ∥w∥² is the square of the size of the normal vector “w”, i.e., wT·w. When a Lagrangian multiplier is used to solve Equation (6), the below Equation (7) can be accomplished.

$$L ( w , b , α ) = \frac{1}{2} {‖ w ‖}^{2} - {\sum }_{i = 1}^{l} {α}_{i} \{ [ ( {x}_{i} \cdot w ) - b ] {y}_{i} - 1 \} \qquad ( 7 )$$

Consequently, a dual problem in which a Lagrangian L(w,b,α) is minimum with respect to “w” and “b” and is maximum with respect to “α” may be solved. Under the condition making the Lagrangian minimum with respect to “w” and “b”, two conditions can be obtained as shown in the below Equation (8).

$$\frac{\partial L}{\partial b} = 0 ⇒ {\sum }_{i = 1}^{L} {α}_{i} {y}_{i} = 0 \\ \frac{\partial L}{\partial w} = 0 ⇒ w = {\sum }_{i = 1}^{l} {α}_{i} {x}_{i} {y}_{i} \qquad ( 8 )$$

When the conditions obtained by Equation (8) are applied to Equation (7), the below Equation (9) may be accomplished.

$$\overline{α} = arg {min}_{α} \frac{1}{2} {\sum }_{i = 1}^{l} {\sum }_{j = 1}^{l} {α}_{i} {α}_{j} {y}_{i} {y}_{j} ( {x}_{i} \cdot {x}_{j} ) - {\sum }_{i = 1}^{l} {α}_{i} \\ subject to {\sum }_{i = 1}^{l} {α}_{i} {y}_{i} = 0 \qquad ( 9 )$$

When w(^{\overline{w}}) with respect to the optimal hyperplane and b(^{\overline{b}}) with respect to the optimal hyperplane are expressed using ^{\overline{α}} obtained using Equation (9), the below Equation (10) can be obtained.

$$\overline{w} = {\sum }_{i = 1}^{l} {\overline{α}}_{i} {x}_{i} {y}_{i} \\ \overline{b} = \frac{1}{2} \overline{w} \cdot [ {x}_{r} + {x}_{s} ] \qquad ( 10 )$$

Here, xᵣ and xₛ may be arbitrary support vectors at respective points where yᵢ is 1 and −1, respectively. Then, the optimal hyperplane is expressed by the below Equation (11) and the discriminant of the optimal hyperplane will be f(x) in the below Equation (12).
\overline{w}·x−\overline{b}=0 (11)
ƒ(x)=\overline{w}·x−\overline{b} (12)

Since points at which f(x)=0 forms the optimal hyperplane expressed by Equation (11), an image can be discriminated as including eyes when f(x) is greater than 0 and discriminated as not including eyes when f(x) is less than 0.

The above description concerns a case where the training data can be linearly divided. When the training data cannot be linearly divided, a kernel function may be used. In this case, \overline{α} in Equation (9) may be expressed by the below Equation (13):

$$\overline{α} = arg {min}_{α} \frac{1}{2} {\sum }_{i = 1}^{l} {\sum }_{j = 1}^{l} {α}_{i} {α}_{j} {y}_{i} {y}_{j} k ( {x}_{i} \cdot {x}_{j} ) - {\sum }_{i = 1}^{l} {α}_{i} \\ subject to {\sum }_{i = 1}^{l} {α}_{i} {y}_{i} = 0 \qquad ( 13 )$$

Here, k(xᵢ·xⱼ)=Φ(xᵢ)·Φ(xⱼ) and Φ(x) is a space mapping function. When the result of Equation (13) is used, a hyperplane may be obtained like when input data is linear.

Meanwhile, when the discrimination section 524 discriminates whether an image includes eyes, an input image vector may be applied to the discriminant of the optimal hyperplane like Equation (12) and it may be determined whether a resultant value exceeds a predetermined threshold value. Although the threshold value may be simply set to 0, it may be set to a value greater than 0 in order to prevent a “false positive” from occurring when an image not including eyes is incorrectly recognized as an image including eyes. The threshold value may be adaptively selected according to empirical statistics by cases.

As described above, the training data storage unit 260 may store training data used by the binary classifier 410, included in the eye candidate verification unit 240, and the binary classifier 520, included in the final verification unit 250, to learn a discrimination reference. The training data storage unit 260 may be divided into the left eye/right eye training data storage 262 and the eye pair training data storage 264, for example. The left eye/right eye training data storage 262 for the binary classifier 410, included in the eye candidate verification unit 240, may include data used to learn whether an image includes a left eye and data used to learn whether an image includes a right eye. The eye pair training data storage 264 for the binary classifier 520, included in the final verification unit 250, may include an image including both eyes and an image not including an eye.

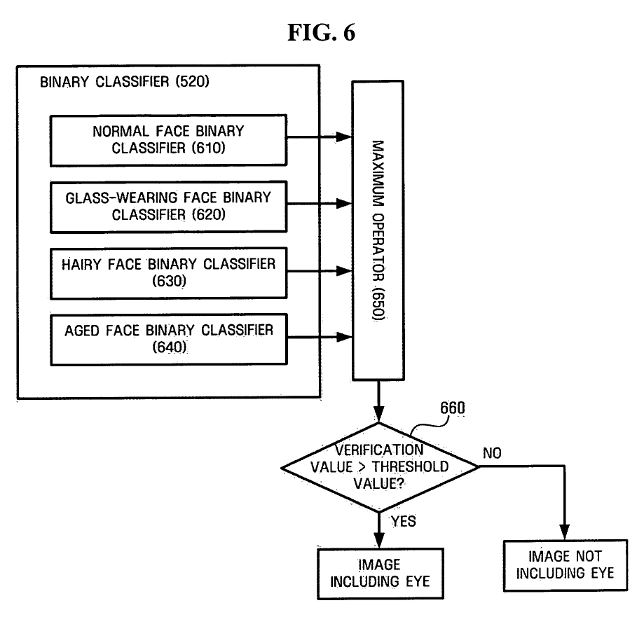

FIG. 6 illustrates a final verification unit, according to another embodiment of the present invention.

An image including human eyes may vary with the characteristics of a face. Such an image can be verified using a single binary classifier, but when a plurality of binary classifiers for various facial characteristics are used, more accurate verification results may be obtained. For example, such characteristics may include a normal face, a face wearing glasses, a face covered with hair, and a face of an aged person have different characteristics. Therefore, images including an eye may also have different characteristics. When a discrimination reference, obtained through learning of normal faces, is used in discriminating an image including an eye with respect to a face wearing glasses, the characteristics of the glass-wearing face may be ignored, and therefore, an unsatisfactory result may be obtained. Accordingly, as shown in FIG. 6, the binary classifier 520 may be implemented by a plurality of binary classifiers 610 through 640 which may be trained for different facial characteristics, respectively. Here, a pair of second eye candidates may be verified by the plurality of the binary classifiers 610 through 640 and a maximum verification value may be obtained from the verification results by a maximum operator 650. Next, an image of the pair of second eye candidates may be discriminated according to whether the maximum verification value exceeds a threshold value. Here, training data for the plurality of binary classifiers 610 through 640 may be divided into different types of training data reflecting their facial characteristics, respectively, i.e., training data for a normal face, training data for a face wearing glasses, training data for a face covered with hair, etc.

In FIGS. 2 through 6, each of various components can be implemented through, but is not limited to, software and/or hardware components, such as a Field Programmable Gate Array (FPGA) or Application Specific Integrated Circuit (ASIC), which may perform certain tasks. A module may advantageously be configured to reside on the addressable storage medium and configured to execute on one or more processors, for example. The operations provided by the components may be combined into fewer components and modules or further separated into additional components. In addition, the components may be implemented such that they execute one or more computers in a communication system.

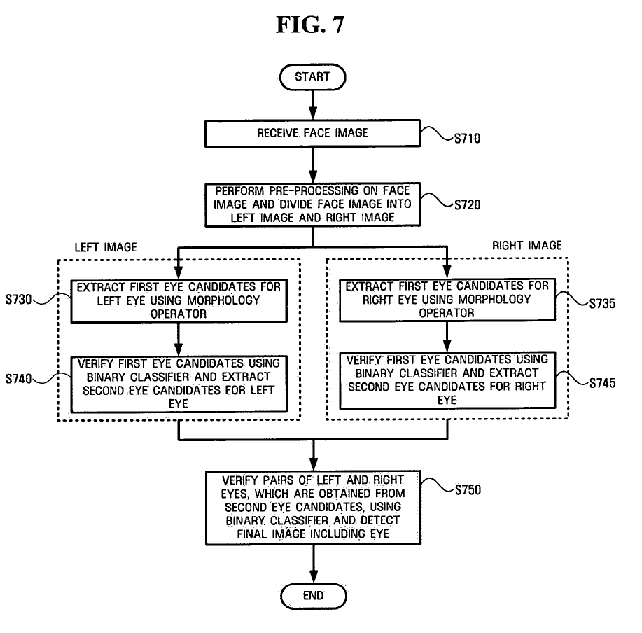

FIG. 7 is a flowchart of an eye detecting method, according to another embodiment of the present invention.

In operation S710, a face image may be received through the image input unit 210. In operation S720, the image pre-processing unit 220 may perform pre-processing, such as size adjustment or histogram normalization, on the face image to divide the face image into a left image and a right image. In operation S730, the eye candidate extraction unit 230 may apply a morphology operator to the left image and extracts first eye candidates for a left eye. In operation S740, the eye candidate verification unit 240 may verify the first eye candidates for the left eye using the binary classifier 410 and extract three or four second eye candidates for the left eye. Meanwhile, in operation S735, the eye candidate extraction unit 230 may apply the morphology operator to the right image and extracts first eye candidates for the right eye. In operation S745, the eye candidate verification unit 240 may verify the first eye candidates for the right eye using the binary classifier 410 and extract three or four second eye candidates for the right eye. In operation S750, the final verification unit 250 may verify all pairs of left and right eyes, which may be generated by combinations of the second eye candidates for the left eye and the second eye candidates for the right eye, (e.g., nine pairs of eyes when three second eye candidates are extracted for each of the left and right eyes) using the binary classifier 520 and detect a final image including an eye. In operation S750, training of the binary classifier 520 may be further performed.

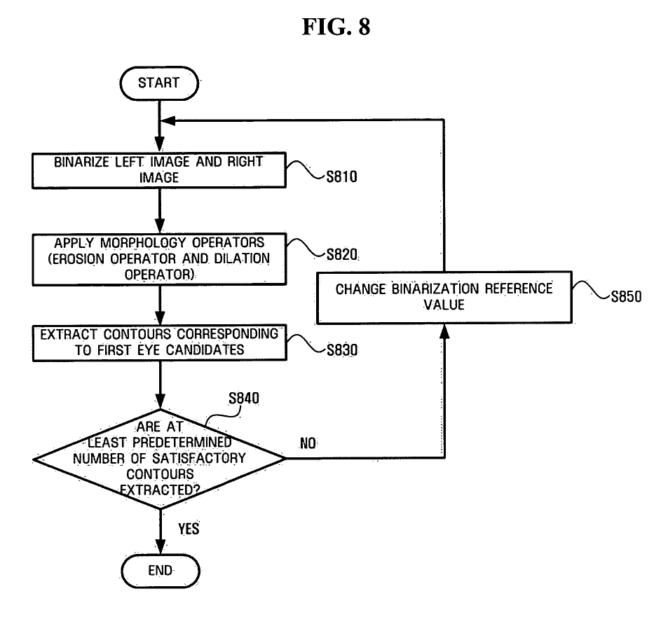

FIG. 8 is a flowchart illustrating a first eye candidate extraction, such as that performed in operations S730 and S735 shown in FIG. 7, according to an embodiment of the present invention.

In operation S810, a binarizer, such as binarizer 310 included in the eye candidate extraction unit 230, may binarize the left image and the right image. In operation S820, a morphology operation section, such as the morphology operation section 320, may extract noise-removed feature points using an erosion operator and a dilation operator. In operation S830, a contour extractor, such as contour extractor 330, may extract contours from the feature points and extract central coordinate values of the respective contours. When at least a predetermined number of satisfactory contours, e.g., at least three satisfactory contours, are not extracted in operation S840, a binarization reference value may be changed in operation S850 and then operations S810 through S830 may be repeated.

Whether a contour is satisfactory may be determined according to a length-to-width ratio of the contour, the number of pixels in the contour, etc. Generally, since the pupil of the eye is circular, the length-to-width ratio of the pupil approximates to 1:1 or is about 2:1 even when the pupil is partially hidden by eyelashes. Accordingly, when the length-to-width ratio of the contour is within a range of that of the pupil, the contour may be determined as being satisfactory. In addition, since the size of an entire face is known, the size of the eye can be estimated. Here, if the number of pixels in the contour is within a range of the estimated size of the eye, the contour may be determined as being satisfactory.

When at least a predetermined number of satisfactory contours are not extracted, a change value of the binarization reference value may be adaptively determined according to the result of extracting contours. For example, when no contour is extracted, an increment of the binarization reference value may be set to be large. In addition, the length-to-width ratio or the number of pixels, which has been set as the condition of a satisfactory contour, may be changed.

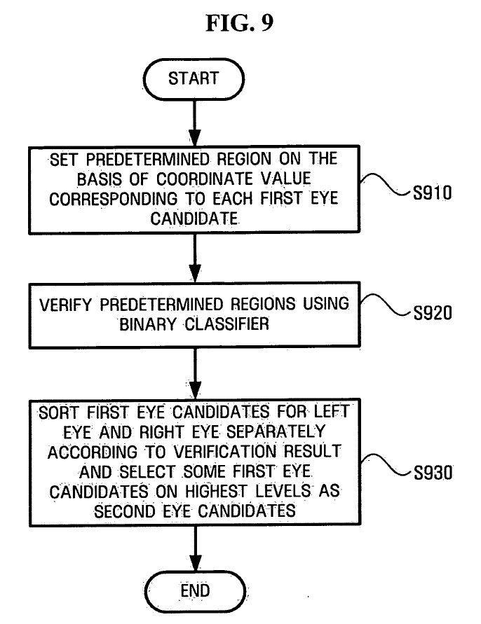

FIG. 9 is a flowchart of a second eye candidate extraction, such as that performed in operations S740 and S745 shown in FIG. 7, according to an embodiment of the present invention.

In operation S910, an eye candidate verification unit, such as the eye candidate verification unit 240, may set as a search region a predetermined region on the basis of a coordinate value corresponding to each of the first eye candidates extracted for the left and right eyes, such as in operations S730 and S735, respectively. In operation S920, a discrimination section, such as the discrimination section 414 of the binary classifier 410 included in the eye candidate verification unit 240, may verify search regions for the first eye candidates for the left eye and the first eye candidates for the right eye. In operation S930, a sorter, such as sorter 420 included in the eye candidate verification unit 240, may sort the first eye candidates for the left eye and the first eye candidates for the right eye according to the result of the verification and selects as second eye candidates some of the first eye candidates with the highest levels for each of the left and right eyes from the sorted result. In operation S930, training of a binary classifier, such as binary classifier 520 included in the final verification unit 250, may be further performed.

An operation of learning a discrimination reference for discriminating an image including an eye using images including an eye and images not including an eye with respect to each of the left and right eyes may be further performed.

As described above, in embodiments of the present invention, a face image may be divided into a left image and a right image and candidates for the left eye and candidates for the right eye may be independently extracted, and therefore, embodiments of the present invention are robust to illumination.

In addition, accurate detection can be achieved for both of the left and right eyes.

Moreover, since first eye candidate data for each of the left and right eye may be primarily filtered using a binary classifier and then pairs of left and right eyes, which are generated from the filtered eye candidate data, are verified using another binary classifier, the positions of the left and right eyes can be detected quickly and accurately.

As briefly noted above, and in addition to the above described embodiments, embodiments of the present invention (or aspects of the same) can also be implemented through computer readable code/instructions in/on a medium, e.g., a computer readable medium. The medium can correspond to any medium/media permitting the storing and/or transmission of the computer readable code.

The computer readable code can be recorded/transferred on a medium in a variety of ways, with examples of the medium including magnetic storage media (e.g., ROM, floppy disks, hard disks, etc.), optical recording media (e.g., CD-ROMs, or DVDs), and storage/transmission media such as carrier waves, as well as through the Internet, for example. The media may also be a distributed network, so that the computer readable code is stored/transferred and executed in a distributed fashion.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An apparatus for eye detection, comprising:
an image pre-processing unit to pre-process an input face image to divide the input face image into a left image and a right image;
an eye candidate extraction unit to apply a morphology operator to each of the left and right images and to extract data on first eye candidates for a left eye and data on first eye candidates for a right eye;
an eye candidate verification unit to verify the data on the first eye candidates of the left eye and the data on the first eye candidates of the right eye using an eye candidate verification unit binary classifier and extracting respective data on second eye candidates for each of the left and right eyes; and
a final verification unit to verify data on pairs of left and right eyes, generated from the respective data on the second eye candidates for the left and right eyes, using a final verification unit binary classifier and extracting final eye data.

2. The apparatus of claim 1, further comprising a training data storage unit to store training data to train the eye candidate verification unit binary classifier and the final verification unit binary classifier for a discrimination reference.

3. The apparatus of claim 1, wherein the image pre-processing unit performs histogram normalization on the face image and divides the normalized face image into the left image and the right image.

4. The apparatus of claim 1, wherein the eye candidate extraction unit comprises:
a morphology operation section to apply the morphology operator to each of the left and right images; and
a contour extractor to extract respective contours from each of the left and right images that have been subjected to the application of the morphology operator and to obtain central coordinate values of the respective contours.

5. The apparatus of claim 4, further comprising a binarizer to separately binarize the left image and the right image.

6. The apparatus of claim 4, wherein the respective contours satisfy a predetermined condition.

7. The apparatus of claim 1, wherein the eye candidate verification unit comprises:
the eye candidate verification unit binary classifier to verify a predetermined region according to each first eye candidate; and
a sorter to sort the first eye candidates according to a verification result and selecting at least some of the first eye candidates based on highest levels from sorted verification results as the second eye candidates.

8. The apparatus of claim 1, wherein the eye candidate verification unit binary classifier comprises:
a learning section learning a discrimination reference; and
a discrimination section verifying input data based on the discrimination reference.

9. The apparatus of claim 1, wherein the eye candidate verification unit binary classifier is an AdaBoost classifier.

10. The apparatus of claim 1, wherein the final verification unit comprises:
a normalizer to normalize data on pairs of left and right eyes; and
the final verification unit binary classifier verifying the normalized data on the pairs of the left and right eyes.

11. The apparatus of claim 1, wherein the final verification unit binary classifier comprises:
a learning section learning a discrimination reference; and
a discrimination section verifying input data based on the discrimination reference.

12. The apparatus of claim 1, wherein the final verification unit binary classifier is a support vector machine (SVM) classifier.

13. The apparatus of claim 1, wherein the final verification unit binary classifier comprises at least two different facial characteristic binary classifiers.

14. A method for eye detection, comprising:
pre-processing an input face image to divide the face image into a left image and a right image;
applying a morphology operator to each of the left and right images and extracting data on first eye candidates for a left eye and data on first eye candidates for a right eye;
verifying the data on the first eye candidates for the left eye and the data on the first eye candidates for the right eye using a first eye candidate binary classifier and extracting respective data on second eye candidates for each of the left and right eyes; and
verifying data on pairs of left and right eyes, generated from the data on the respective second eye candidates for the left and right eyes, using a second eye candidate binary classifier and extracting final eye data.

15. The method of claim 14, wherein the pre-processing of the input face image comprises:
performing histogram normalization on the face image; and
dividing the normalized face image into the left image and the right image.

16. The method of claim 14, wherein the applying of the morphology operator comprises:
applying the morphology operator to each of the left and right images; and
extracting respective contours from each of the left and right images that have been subjected to the application of the morphology operator and obtaining central coordinate values of the respective contours.

17. The method of claim 16, further comprising separately binarizing the left image and the right image before applying the morphology operator.

18. The method of claim 16, wherein the contours satisfy a predetermined condition.

19. The method of claim 16, wherein the applying of the morphology operator and the extracting of the contours are repeatedly performed until contours satisfying the predetermined condition are extracted.

20. The method of claim 14, wherein the verifying of the data on the first eye candidates comprises:
verifying a predetermined region based on each first eye candidate using the first eye candidate binary classifier; and
sorting the first eye candidates according to a verification result and selecting at least some of the first eye candidates based on highest levels from sorted verification results as the second eye candidates.

21. The method of claim 20, further comprising learning a discrimination reference using the first eye candidate binary classifier, wherein the verifying of the predetermined region further comprises verifying the predetermined region according to the discrimination reference.

22. The method of claim 14, wherein the first eye candidate binary classifier is an AdaBoost classifier.

23. The method of claim 14, wherein the verifying of data on pairs of left and right eyes, comprises:
normalizing the data on pairs of left and right eyes; and
verifying the normalized data on pairs of the left and right eyes.

24. The method of claim 23, further comprising learning a discrimination reference using the second eye candidate binary classifier, wherein the verifying of the predetermined region further comprises verifying the predetermined region according to the discrimination reference.

25. The method of claim 14, wherein the second eye candidate binary classifier is a support vector machine (SVM) classifier.

26. The method of claim 14, wherein the second eye candidate binary classifier comprises at least two different facial characteristic binary classifiers.

27. At least one medium comprising computer readable code to implement the method of claim 14.

28. A apparatus for eye detection, comprising:
a means for pre-processing an input face image to divide the face image into a left image and a right image;
a means for applying a morphology operator to each of the left and right images and extracting data on first eye candidates for a left eye and data on first eye candidates for a right eye;
a means for verifying the data on the first eye candidates for the left eye and the data on the first eye candidates for the right eye and extracting respective data on second eye candidates for each of the left and right eyes; and
a means for verifying data on pairs of left and right eyes and extracting final eye data.
